(19) United States
(12) Patent Application Publication
(10) Pub. No.: US 2002/0103634 A1
(43) Pub. Date: Aug. 1, 2002

(54) Method and apparatus for unsupervised transactions

(76) Inventor: Melih Ogmen, Ariss (CA)

Correspondence Address: Orange & Chari, Suite 4900, 66 Wellington Street West, P.O. Box 190, Toronto, ON, M5K 1H6, CA

(21) Appl. No.: 10/034,204

(22) Filed: Jan. 3, 2002

(30) Foreign Application Priority Data
Jan. 3, 2001 (CA) 2,330,196

(51) Int. Cl. G06F 17/27

(52) U.S. Cl. 704/9

(57) ABSTRACT

A method performed by a machine comprises obtaining instructions from a user to perform a task; gathering information from a network of machines; processing the information in accordance with the instructions; and reporting the result of the task to the user.

### BACKGROUND OF THE INVENTION

1. Field of the Invention

The present invention relates to computer networks, and more specifically to a network of machines for performing unsupervised operations.

2. Description of the Prior Art

With current PC and the WWW technologies, the user is essentially a willing slave to the PC. No. benefits can be achieved from the PC and WWW technologies unless the user is sitting in front of a computer.

In order to function, computers require human operators to interpret the information provided, and to instruct the computer on the next step to take.

Over the last 50 years two divergent meanings for the word language developed, namely language as in human languages and language as in computer programming languages. Computer languages are a set of highly defined rules for creating a list of instructions. A human language is a symbolic system for communicating ideas, emotions and desires. Though both information transfer systems are termed a language, they have very little, if anything in common.

Human intelligence and human language are strictly interlinked and feed from each other. More importantly, the association between these two elements occurs within the medium of social interaction. Nothing can be intelligent in total isolation.

The AI community spent more than two decades trying to program computers and the like by using a variety of computer languages to mimic human intelligence with limited success. There are two reasons for this lack of success: the use of an inappropriate, or sometimes a total lack of, interaction medium and the use of inappropriate languages (i.e. computer languages as defined above).

### SUMMARY OF THE INVENTION

In accordance with one aspect of the present invention, there is provided a method performed by a machine, the method comprising the steps of: obtaining instructions from a user to perform a task; gathering information from a network of machines; processing the information in accordance with the instructions; and reporting the result of the task to the user.

### BRIEF DESCRIPTION OF THE DRAWINGS

These and other features of the preferred embodiments of the invention will become more apparent in the following detailed description in which reference is made to the appended drawings wherein:

FIG. 1 is a schematic representation of a computer network.

FIG. 2 is a schematic representation of a machine used in the network of FIG. 1.

FIG. 3 is a more detailed view of a portion of FIG. 2.

FIG. 4 is a representation of a data structure used in the machine of FIG. 2.

FIG. 5 is a schematic of a derivation of the data structure of FIG. 4.

FIG. 6 is a schematic illustration of a further embodiment.

FIG. 7 is a schematic illustration of a still further embodiment

### DESCRIPTION OF THE PREFERRED EMBODIMENTS

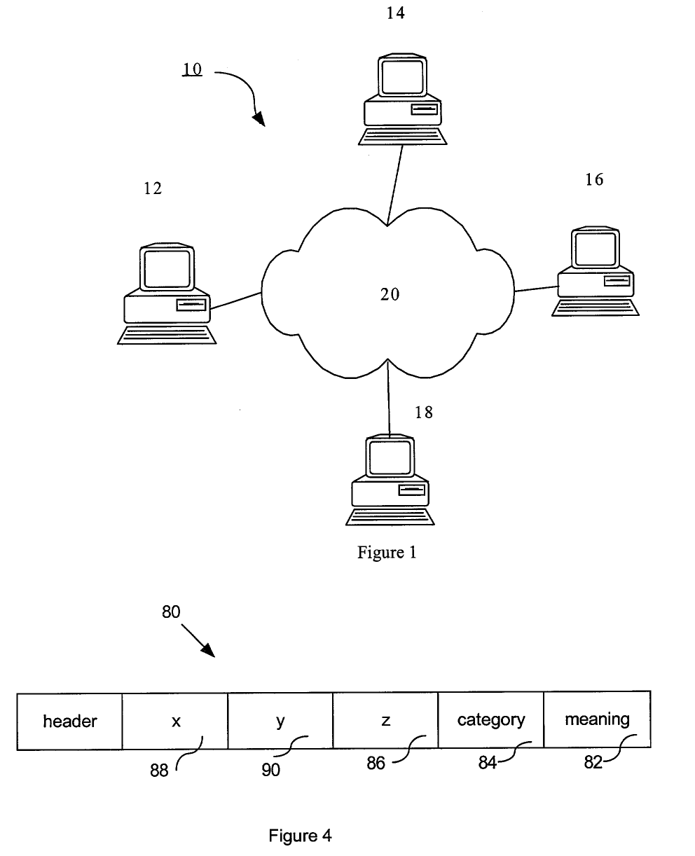

Referring to FIG. 1, a data communication system is shown generally by the numeral 10. The system 10 comprises machines 12, 14, 16, 18 connected to each other through a data communication system 20. The network 20 can be defined as the mirror or shadow of the Internet in terms of its information content. It is designed to be used exclusively by PCs and other PC like devices, collectively designated the machines 12-18 and to function on the network 20 without human intervention, other than that necessary to obtain starting instructions.

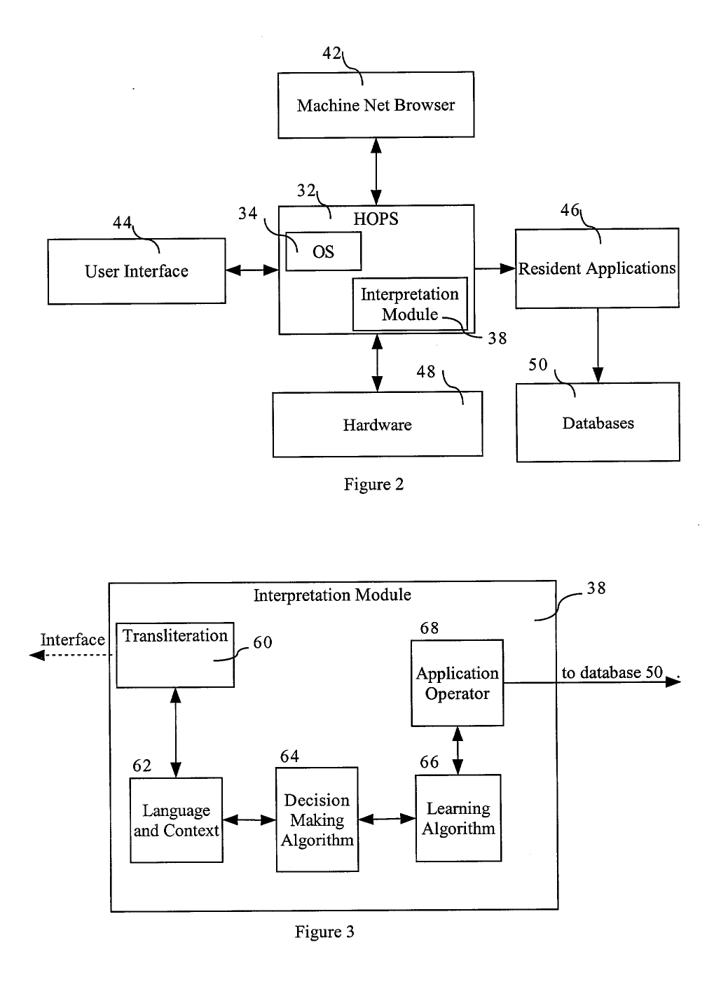

At least one of the machines 12-18, for example the machine 12 shown in more detail in FIG. 2, includes a high level operating system (HOPS) 32 to facilitate communication over the network 20. Other machines 14-18 may also utilise a HOPS 32 but as will be explained below only one such machine is necessary to achieve finctionality on the network 20.

HOPS 32 includes a conventional operating system 34, such as DOS or Windows for controlling operation of a browser 42, a user interface 44, resident applications 46, and hardware 48. The browser 42 is configured to exchange data over the network 20 between the machines 12-18 and the resident applications 46 create and maintain databases 50 and provide access to databases 50 through the HOPS 32 to permit storage of and retrieval of information. The user interface 44 enables instructions to be directed to the HOPS 32 from a user and for the HOPS 32 to direct further queries or provide results of queries to the user. HOPS 32 controls hardware 48 such as hard disks, video cameras, and microphones through the native operating system 34. HOPS 32 also includes an interpretation module 38 that receives natural language information and converts it into an organic intercommunication language to be used by the machine 12.

Referring to FIG. 4, interpretation module 38 is shown in more detail. The interpretation module includes an analysis and transliteration engine 60 that converts the natural language in to a numerical code indicative of the meaning of a word and its function within a sentence, as will be described more filly below. Ambiguities occurring in the transliteration engine 60 are resolved in a language and context function 62 which also enriches the transliteration by incorporating an indication of context. Resolution of ambiguities and attribution of context is facilitated by a decision making algorithm 64, which interfaces with a learning algorithm 66 utilising history of the machine 12 to provide input to the decision making algorithm. The history is made available from the resident applications and databases 50 by an application operator 68. The decision making algorithm can use either fuzzy logic or chaotic logic and operates to control the function of the machine 12. As the machine operates, the learning algorithm 66 continually improves its functioning and stores knowledge as language and context function 62. The decision-making algorithm 64 also has access to a temporary search database 70 for storage and retrieval of information during operation.

In order for a machine readable representation of a word to function in a manner analogous to the human language it is necessary for it to denote the same attributes as a word in such a language, namely its meaning, context and the role and emphasis or importance within the sentence. This is obtained by creating for each word or other unit of information such as a phrase, clause, maxims or aphorisms a data structure indicated at 80 in FIG. 4.

The transliteration engine 60 operates to accord a unique number to each word that provides both meaning and context. Each of the human words, phrases, proverbs, maxims, and aphorisms from all human languages are mapped, preferably using a 32 bit numbering system. Considering the fact that a 32-bit number contains approximately 4.3 billion combinations there will be ample opportunity to structure the vocabulary so that future expansion and dynamic modification of the vocabulary can be possible.

Thus, by way of example, the word “eat” will be accorded a numerical code of 16 bit length indicated at 82. The same code is accorded to the corresponding German word “essen” and French word “manger” to allow equivalent words to be identified in different human language documents.

A particular word may however have more than one meaning leading to ambiguities. For example, the verb “to see” can mean either to discern visually or to understand. In the first case, the corresponding German word is “sehen” and in the second it is “verstehen.” The word “see”is therefore given two possible values, each mapped to corresponding words in other languages. The ambiguity of which is correct is resolved from the context of the word.

The organization of number assignment to various human language words is arranged in such a way that further benefits from such a mapping system can be realized with ease and contributes towards establishment of context for a given sentence. For example words that fall into the same categories within a thesaurus scheme are numerically grouped by according a eight bit number 84 that indicates the thesaurus grouping. Thus, in the example of “see,” the meaning of visual discernment is accorded a numerical code of the thesaurus group of perception and the meaning of understand is accorded the numerical code for “comprehension.” In this manner, words within the same numerical group may be identified as potential replacement words in structuring a search.

The grammar of the natural language is conveyed in the machine language in a strictly positional as opposed to inflectional manner. Each word therefore has a numerical identifier indicative of meaning and context. The role of the word within a sentence also contributes to the ability to understand the idea conveyed by the series of words making up the sentence. The role of the word is a function of the grammar of the natural language.

The word order of the grammar can be any of the six combinations of Subject, Verb, and Object. In this embodiment, the order Subject, Verb, Object is used for convenience due to its familiarity to the English speaking population.

Sentences in machine language are represented as structure in the form of three or higher dimensional matrixes. For ease of explanation, a three dimensional matrix is used for the description of the concept.

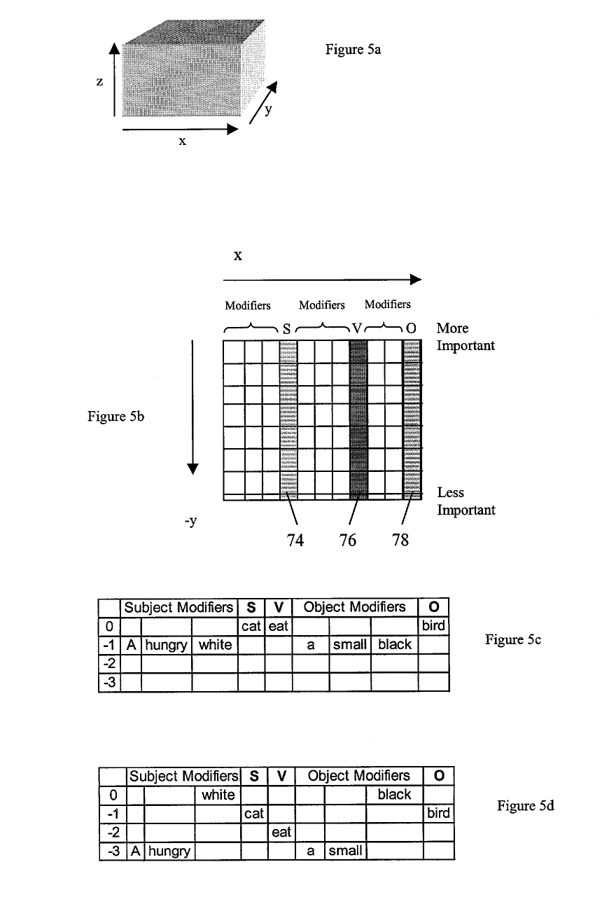

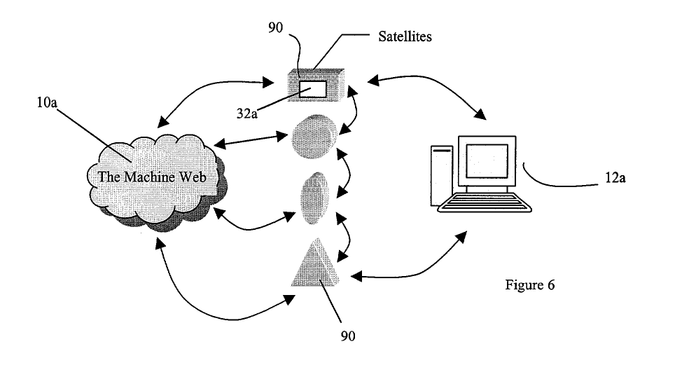

As shown in FIG. 5a, the dimensional axes of the matrix correspond to the following:

x. word role

y. relative importance of sentence elements

z. time order.

The sense of time within the sentence for both tenses of verbs and time modifying sentence elements (e.g. before, after etc.) are organized as x-y planes with different z values. All positive integer z values correspond to future events moving progressively further with increasing z value. Similarly the negative z values then correspond to events that are in the past. Z=1 is reserved for the present and z=0 is reserved for truth statements, time independent activities etc. For example statements such as “I work” or “we fear” or “hydrogen is lighter then oxygen” will all have a z=0 value in their matrix entries, since they are time independent. The value of the z plane recorded at 86 in the data structure 80 of FIG. 4.

A skipped z value within the matrix structure indicates a completed action.

This timing scheme helps to accommodate varying number of tenses in different human languages as well as individual schemes that are developed within each human language to identify tenses by modifying the verbs.

For a given z value of the sentence matrix, the corresponding x-y plane is organized as shown in FIG. 5b to signify the role or function of the word in a sentence and its significance in the sentence. Spaced columns 74,76,78 in the matrix indicate the principle functions of the word in the sentence, namely subject, verb, and object in the example given and adjacent columns qualify the respective one of the columns. Each column has an x value which is recorded at 88 in the data structure 80 for that word with the positions of the principle functions fixed for reference purposes.

The position of the row on the matrix is used to indicate the relative importance of a word in the sentence. The top left comer of the grid (for a given z value) can be assumed y=0. As the magnitude of negative y values gets progressively larger, the relative importance of that particular word within the sentence is gradually diminished. The y value is recorded at 90 in the data structure 80.

As a general example, consider the sentence: “A hungry white cat ate a small black bird” as illustrated in FIG. 5c.

This sentence has a z value of −1 since it happened in the past, i.e. the verb to eat is in the past tense, ate. Accordingly there is no need to use the past tense of the verb “eat” in the column 76 since this is signified by the z value of the plane of the sentence. The verb “eat” is given a numerical code that identifies the word eat and the category to which it relates.

Similarly the word “cat” is identified as the subject and located in the column 72 with a numerical value corresponding to the word “cat” that is a subset of the group of numbers associated with the category of “animals”. The word “bird” is located in column 72 as the subject but the transliteration engine determines two possible meanings of bird, either an animal that flies or a sound indicating derision. The ambiguity is referred to the language and context function 62 which resolves the ambiguity and indicates the appropriate numerical value.

The resolution of the ambiguity is achieved utilising the decision making algorithm 64 and the learning algorithm 66. As noted above, the decision making algorithm may be implemented as a fuzzy logic function having a set of inputs and a rule structure to return a particular result for a given set of inputs. The decision making algorithm 64 may take as one set of inputs the category of other words within the sentence to determine which is the correct meaning, e.g. the fact that “cat” is also of the “animal” category, and may, as another input access the learning algorithm to determine past activities of the user. In this situation the learning algorithm accesses the past queries database and notes that each of the past queries have been categorised as “animal”related. On the basis of these inputs, the rule set of the decision making algorithm determines the correct word is that in the animal category and attributes the appropriate numerical value to it.

The position of the words on the y axis identify the relative importance of the word in the sentence. In the example of FIG. 5c, the words “cat”, “eat”, and “bird” are accorded high importance and the modifiers accorded a lesser importance. Accordingly an inference is that the sentence is primarily related to animal habits and the sentence emphasizes the fact that a cat ate a bird. All attributes of the cat and/or the bird are secondary to the main activity conveyed by the sentence.

The same sentence can be represented in the matrix in many alternative ways to change the emphasis. The sentence representation shown in 5d in which the colours are accorded primary importance converts the meaning of the sentence to an interplay between colours black and white and de-emphasizes the act of eating.

Accordingly the words forming a sentence may be represented as a set of numerical values, each having a position within a co-ordinate field that together provides meaning, significance and contextual information . The resulting data structure 80 may then be used to identify information meeting specified criteria.

Given the grammar rules and conventions that are described above, every sentence within the natural language can be examined for several aspects to derive contextual information. First of all each individual pattern that is formed at consecutive x-y planes of the matrix provide the information on the emphasis. This pattern clearly shows whether the emphasis is on the object, verb, subject or on one or more of the modifiers of the sentences. Furthermore the relative pattern emphasis between the layers of the matrix also indicates the emphasis in the timing aspect of the sentence, e.g. the representation of the verb “eat” on the z =−1 plane at highest importance indicates emphasis on past actions.

A given sentence can be further analyzed for “concept relationships”. There are occurrences in human speech where a word might have several potential meanings. When the pattern emphasized words are further analyzed with respect to their thesaurus grouping, it will be possible to uncover other potential meanings for a given sentence. For instance the sentence emphasized in a manner that is shown in FIG. 5d might lead to a conclusion that though the discussion seems to be about the feeding habit of a particular cat, in fact, it is about the struggle between the forces of good and evil i.e. white vs. black. In the context of a search, this facility allows the machine to locate information that would otherwise not be considered.

When the pattern emphasis analysis and the concept relationship analysis are performed on sentences and paragraphs represented in this manner it is possible for a machine to extract from the data structure the contextual information that is conveyed by a document containing a human language.

Given a well defined grammatical structure for the machine language and a vocabulary set which contains all words that exist in any given language it is possible to develop translation programs to convert any common language to the machine language and vice versa. In this manner an enhanced search or information retrieval capability is obtained.

Every web page and potentially all available documents that are created in any human language can be represented as a data structure 80 translated into this “universal” machine language and hence can be made available for the use of the machines 12.

To better describe the characteristics of the network 10 and HOPS 32 an example of the user attempting an information collection from the machines connected to the network 20 is presented. Initially, the user communicates with the machine 12 via the user interface 44 to initiate a task such as a search. The communication between the machine and the user can be any of the conventional means ranging from voice recognition to keyboard entry.

The machine HOPS 32 uses the interpretation module 38 to translate the user's language to machine language and provide a data structure indicative of the context of the request. From the data structure representing the request a search strategy is implemented to identify information relevant to the request. This may for example initially be the identification of specific words accorded the highest importance, i.e. y =o, in the request or combinations of specific words “eat” and contextual grouping “animal.” This information is then passed onto the Decision-Making Algorithm (DMA) 64 within the HOPS 32. DMA 64 initiates a search, first on the existing local databases 50 to identify relevant information that might stored locally. Assuming that the request could not be satisfied locally, DMA 64 opens up the browser 42 through the application operator sub system.

Using the browser 42 a search is initiated using one or many of the conventional searching techniques. The browser searches all available web sites and analyzes their contents using the language/context sub system of HOPS 32 for their relevance.

If a relevant section within a web page is identified then the DMA 64 creates a temporary search database 70 and copies the site information and the document into this database, linking this information to the initial search criteria that was selected.

The searching and saving to the temporary database 70 continues until all available web sources are exhausted or some pre-established search parameter limits such as duration are reached. At this point the DMA 64 slightly varies the search key words or phrases by using the pattern emphasis and thesaurus-grouping techniques as explained above. For example, “eat” may be broadened to the category to which it relates and the time parameter may be narrowed to actions in the past (z =−1). Further searches are then initiated by the DMA 64 as before using the new phrases and keywords. This repetitive process stops when the user established goal or the search criteria is satisfied.

The fact that all of the information that is gathered to this point is in the machine language enables DMA64 to “understand” the context and meaning of all of the documents that are stored within the temporary search database. The DMA 64 then generates several parameters that will be used as criteria for the final decision making process.

These parameters can be, by way of example,:

the original search criteria that was inputted by the user,

the relevance tags that are generated for the captured documents and/or their subsections,

documents that are captured by several different search criteria

and other parameters based on past history of the user.

These are then used with Fuzzy Logic (FL) and/or Chaotic Logic (CL) decision making systems embedded in the DMA 64, depending on the diversity or complexity of the results at hand.

The DMA 64 finally creates a summary document or a final report based on the results obtained by the content analysis and the decision making systems. This document includes text, which is compiled from many different documents and direct links to the original sites where each sub section was obtained. The final summary document is then translated from the machine language to the users own human or natural language.

The DMA 64 then initiates the learning algorithm 66 and stores the key aspects of the search in a permanent database as well as the final document that is created for the user and subsequently eliminates the temporary database 70.

A key characteristic of the HOPS 32 is that it can function without any input or intervention from the user (a human) within the operating parameters that are set by the user. Accordingly, by using Internet crawlers and robots the Internet can be constantly scanned, translated and its image stored in servers. The images are stored as translations performed by the interpretation module. As a result, a mirror of the Internet is created in the machine language. The machines 12-18, which run the High-level Operating System 32, will then be able to access the network 20 directly. In accordance with a request from a user, they will then be able to gather, process and repackage the information therein without any direct human intervention.

Through the use of peer-to-peer file sharing technology, user files that are not copy righted can be searched and downloaded by all clients that are on the network 10. If the peer-to-peer system that is used by the network 10 turns out to have central servers then these servers can be organized to ensure efficient location of information by the machines 12-18.

In a further embodiment, the individual machines may analyse or become aware of their own content. They will know and “understand” the content of the web page that is associated with them as well as the contents of all the files that are stored in various locations in their databases and hard-drives. This will open up the possibility of a machine asking a content related question to a specific member of the network or to a number of members that are associated with that subject matter.

A question in the machine language such as “do you have information on . . .?” will be transmitted to a relevant peer-to-peer server on the network 20 by the HOPS 32. The server will respond by identifying network members that might have the right answer. The machine originating the question will then broadcast the question to those members. In turn these machines will answer back to the original machine directly thereby eliminating the need to search for answers in machines where there are none. In the long run the broadcasting questions over the network will replace the common search techniques. The above embodiments have been described using the example of information retrieval. However, the techniques may be applied to other areas where messages utilise the data structure

In a still further embodiment, the potential of virus infection of the machines may be mitigated.

Each computer utilising the HOPS 32 will be able to “understand” the content and meaning of each message that is received over the network and each document that arrives whose content indicates a virus may be identified by HOPS 32 before they can take move further into the hardware of the machines. The DMA 64 is used in this context to determine if the message is relevant based on past history (e.g. is Snow White relevant to the machine's user), does it originate from a trusted user, are any web sites warning of a potential virus and reject the message when a determination is made.

Similarly the monitoring of messages by the DMA 64 may eliminate all spam and Junk mail from each machine. Creation of viruses as well as spam will be completely traceable to its origin.

In a yet still further embodiment, the peer-to-peer style facilitates the retrieval of copyrighted material whilst respecting the owners rights. The servers associated with this peer-to-peer activity operate the HOPS 32 to determine not only the nature of the request but also whether this is an authorised transaction or not. Authorised transactions can be tracked and billed by the intermediary company instead of the company that is making the intellectual property available on the network, since all of the Machine net users will be registered users of this service. The company, which establishes the machine net company, will also serve as a credit company.

In another embodiment illustrated in FIG. 6, in which like components will be denoted with identical reference numerals with a suffix “a” added, a more sophisticated use of the network 10 a is provided. Its components can be demonstrated by the following description of networked Satellites 90.

A satellite 90 can be defined as a combination of hardware and software designed for a specific application. Networked satellite hardware and software contains the HOPS 32, organic machine language and a means to connect to the machine net. This satellite is then networked with other satellites specializing in different areas of use.

An example of a networked satellite can be a “phone satellite” whose specialised application is retention of contact information. This small box sits somewhere (possibly in multiple locations) in the house and maintains individual and family phone lists as well as capability to make phone calls. A user can communicate with it via voice or another conventional means.

If the user is looking for the phone number then the phone satellite can simply be instructed to undertake a phone number search for the given name. If further information such as potential location (i.e. the European continent or UK) is available this information can also be provided to the phone satellite to reduce the search time or multiple hits.

Satellites being fully capable of performing the tasks without any human operator intervention can run searches for the user for days or weeks in the background until the necessary information is obtained or other pre established criteria is achieved.

To perform the search the satellite hooks on to the network 10a using the capabilities of HOPS 32a and starts systematically searching various information sources in the network, either individually or by broadcasting a question as described above. Such information sources include membership information of various societies, direct name searches etc. for the purpose of potentially identifying a location (guidance search) for the name prior to an in-depth search in phone books.

If the guidance search provides any results then the satellite HOPS 32a analyses them for further clues. From the information that is distilled from the analysis, a phone book search can be initiated for the locations that are previously identified. Every time a match or a close match is recorded, HOPS 32a files this information in a specific database within the satellite.

At the end of the search, the satellite summarizes the results as explained previously and generates a summary document for the user. If the user chooses, the final information can be stored in the more permanent database of the satellite for future reference.

The self initiating nature of the HOPS 32a allows the satellite 90 to maintain and update the contact information on a periodic basis by directing a request to the different sources based on the records of the original search maintained in the database.

The satellites 90 may be networked to share information as well as to maintain distributed knowledge base for the user. For example a “vehicle satellite” will notice that the service time for the vehicle is approaching. It then will automatically:

select the best possible service centre with respect to the type of service the vehicle needs through the network 10a utilizing the user established criteria such as the “most inexpensive place within 15 minutes of driving distance”,

contact service centres to determine available time slots for chosen service centre

connect to the satellite which looks after the day timers for the whole family and will check the appropriateness of the potential booking time slot with respect to the activities of the family,

if there are no conflicts it will book the appointment

it then will transfer this information to the day timer satellite so that it is recorded in all day timers.

it will connect to the phone satellite and through it will contact the user's wife/husband/significant other at work via e-mail (or other means) to transmit the new appointment information.

from the services satellite and the phone satellite it will identify the most appropriate taxi service (fastest or cheapest or with most cars etc.) and will book a taxi cab for the time of the vehicle drop off at the service centre.

it then will report this activity to the user for necessary modifications.

And finally will note all the selections and activities approved by the user and store this information in its permanent database for future reference.

Such interaction is facilitated by the availability of the information from the various sources in a data structure that can be “understood” by the HOPS 32 and context determined.

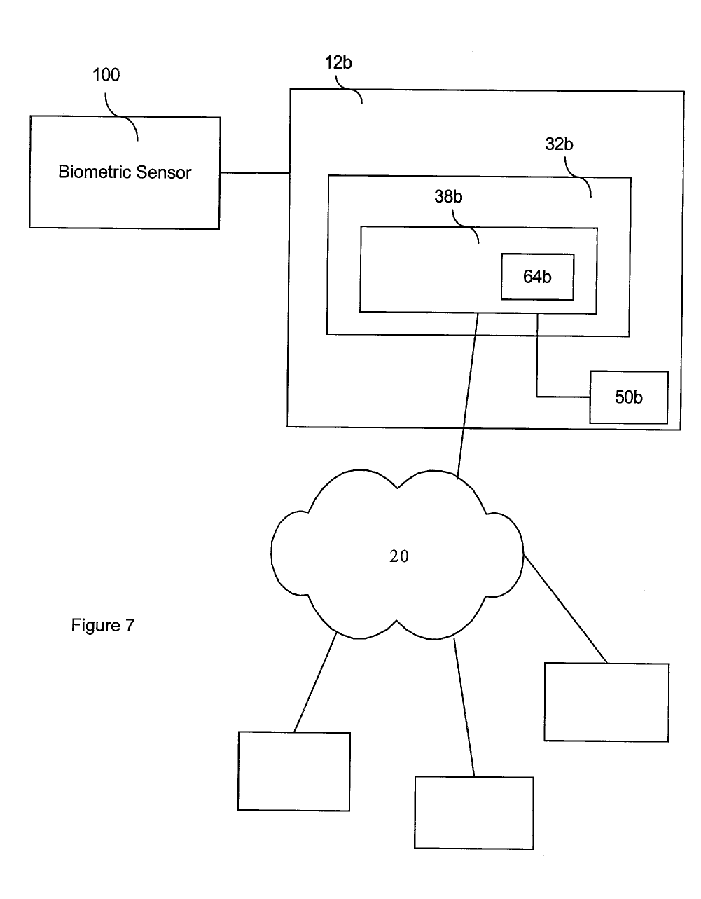

In a further embodiment shown in FIG. 7, the attributes of the machine language are utilised in a security environment. A biometric device 100, such as an iris scan, fingerprint scan or DNA based identification system is provided as an input to a machine 12b. The machine 12b includes as part of the databases 50b a library of identification data from which the scan can be matched. If no match is available, or if further verification is required, a request is structured by the HOPS 32b to locate further information. Once an identity is obtained, either from local databases 50 or via a netwide search, a decision may be made on information available. A search for aliases to the identified party can be conducted, a search of qualifications or work history and information regarding the nature of the facility to being accessed is obtained. The DMA 64b processes these results and determines whether further information is required or whether entry can be approved. If for example, the biometric scan identifies the person as John Doe and the search reveals he is an employee of a power generating station with a PhD in Nuclear Physics with no known aliases, then admission to the nuclear facility is permitted. If however the scan indicates a person with a number of aliases, no fixed addresses and no reason to be entering a nuclear facility, then access would be denied.

Such investigation may also be used to corroborate answers to supplementary questions, such as mothers maiden name, personnel at a particular location where presently employed, or other related information by configuring requests for such data over the network.

In each of the above embodiments, the provision of the information is a data structure that provides meaning, context and significance, in combination with decision making algorithms enables an exhaustive retrieval and screening to be performed in an effective manner.

Although the invention has been described with reference to certain specific embodiments, various modifications thereof will be apparent to those skilled in the art without departing from the spirit and scope of the invention as outlined in the claims appended hereto.

THE EMBODIMENTS OF THE INVENTION IN WHICH AN EXCLUSIVE PROPERTY OR PRIVILEGE IS CLAIMED ARE DEFINED AS FOLLOWS:

1. A method of performing a task by a machine comprising the steps of:
a) providing information to said machine as a data structure indicative of meaning and context of said information in a natural language;
b) identifying data structures meeting criteria defined by said task, and;
c) collecting said identified data structures.

2. A method according to claim 1 wherein said identified data structures are further processed on the basis of context indicated in said data structure.

3. A method according to claim 1 wherein said data structure indicates relative importance of said information in said natural language.

4. A method according to claim 1 wherein said data structure includes an indication of role of said information in said natural language.

5. A method according to claim 1 wherein said data structure is applied to a word of a sentence in a natural language and said data structure indicates role and relative importance of said word within said sentence.

6. A method according to claim 5 wherein said role and said importance of said word are indicated by co-ordinates in a matrix and retained in said data structure.

7. A method according to claim 1 wherein said matrix includes an axis indicating tense of said word.

8. An information retrieval system comprising a collection of information organised as data structures indicative of meaning and context of said information in a natural language, an interpretation engine to convert a query in a natural language in to a corresponding data structure and a search engine to identify common data structures in said query and said collection.

9. An information retrieval system according to claim 8 wherein said translation engine includes a translation device to allocate meaning to said query and a contextual function to provide an indication of context within said structure.

10. A system according to claim 9 including a function implementing a decision making algorithm to determine relative correspondence between said common data structures.

11. A system according to claim 10 wherein said function includes a fuzzy logic algorithm.
